(19) United States
(12) Patent Application Publication
(10) Pub. No.: US 2004/0087373 A1
(43) Pub. Date: May 6, 2004

(54) System and method for interacting with online/offline games using a mobile communication terminal

(75) Inventor: Kyeong-Seon Choi, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/697,754

(22) Filed: Oct. 30, 2003

(30) Foreign Application Priority Data
Oct. 31, 2002 (KR) 2002/67142

(51) Int. Cl. A63F 13/00

(52) U.S. Cl. 463/42

(57) ABSTRACT

A system and method for interacting with online/offline games using a mobile communication terminal. The system includes a mobile terminal and a mobile game server. The mobile terminal downloads a game executable in an offline mode over a communication channel, plays the downloaded game according to an entry command signal, and transmits update information composed of its own number information assigned for communication and a resultant game score over a wireless channel according to an entry command signal. The mobile game server contains a memory for storing the number information of the mobile terminal and the resultant game score corresponding to the number information, detects the number information of the mobile terminal from among the received update information upon receiving the update information from the mobile terminal, and stores the resultant game score in the memory according to the detected number information. Therefore, the mobile terminal gains access to the mobile game server over the wireless channel upon receipt of an entry command signal, and downloads the resultant game score stored in the mobile game server.

### PRIORITY

This application claims priority to an application entitled “SYSTEM AND METHOD FOR INTERACTING WITH ONLINE/OFFLINE GAMES USING MOBILE COMMUNICATION TERMINAL”, filed in the Korean Intellectual Property Office on Oct. 31, 2002 and assigned Serial No. 2002-67142, the contents of which are hereby incorporated by reference.

### BACKGROUND OF THE INVENTION

1. Field of the Invention

The present invention relates generally to a system and method for interacting with online/offline games using a mobile communication terminal, and more particularly to a system and method for interacting with online/offline games using a mobile communication terminal, which downloads a PC online game to the mobile communication terminal, plays a game in an offline mode, transmits the result of the played game to a server over a wireless communication channel or records the same result in the server, such that it successively plays a desired game in an online mode using the real result of the game.

2. Description of the Related Art

Recently, following the current trend of the rapidly growing information and communication industries and also rapidly expanding functions of a mobile communication service, mobile communication terminals (also called mobile terminals) have come to be viewed as necessities of life. With the increasing demands of users who desire to expand or improve functions of mobile communication services, a variety of additional functions in addition to a mobile phone function have been added to the mobile terminals. For example, the additional functions include a background picture setup function, an SMS (Short Message Service) function, an MP3 function, a wireless Internet function, a camera function, a TV function, a VOD (Video On Demand) function, an online/offline game function, etc.

The online/offline game function is classified into a first game available in an online mode (hereinafter referred to as an online game) and a second game available in an offline mode (hereinafter referred to as an offline game). The offline game is downloaded from a predetermined server in the online mode, and is then played only in the offline mode rather than the online mode. The online game is played by a user in the online mode on the condition that the user gains access to the server using the mobile terminal.

Therefore, the user's mobile terminal must gain access to the server before displaying the online game in order to allow the user to play the online game, such that unnecessary charges may be assessed to the user.

### SUMMARY OF THE INVENTION

Therefore, the present invention has been designed in view of the above and other problems, and it is an object of the present invention to provide an interactive game system using a mobile terminal for playing a game, which is executable in online an mode, even in an offline mode, and a method for interacting with online/offline games using the interactive game system.

It is another object of the present invention to provide an interactive game system using a mobile terminal for successively playing a game in the online mode using the result of the game played in the offline mode, and a method for interacting with online/offline games using the interactive game system.

In accordance with one aspect of the present invention, the above and other objects can be accomplished by a system for interacting with an online/offline game, comprising: a mobile terminal for downloading a game that is executable in an offline mode over a communication channel, playing the downloaded game, and transmitting update information including number information of the mobile terminal and a resultant game score over a wireless channel; and a mobile game server, which includes a memory for storing the number information of the mobile terminal and the resultant game score corresponding to the number information, for detecting the number information of the mobile terminal from among the received update information upon receiving the update information from the mobile terminal, and storing the resultant game score in the memory according to the detected number information; wherein the mobile terminal accesses the mobile game server over the wireless channel upon receipt of an entry command signal, and downloads the resultant game score stored in the mobile game server.

In accordance with another aspect of the present invention, there is provided method for interacting with an online/offline game utilizing a mobile terminal and a mobile game server, said mobile terminal for downloading a game that is executable in an offline mode over a communication channel, and playing the downloaded game, and said mobile game server including a memory for storing number information of the mobile terminal and a resultant game score corresponding to the number information, said method comprising the steps of: a) transmitting update information including the resultant game score of the game played and the number information of the mobile terminal over a wireless channel upon receipt of an entry command signal; b) receiving the update information from the mobile terminal; c) detecting the number information of the mobile terminal from the received update information; d) storing the resultant game score included in the update information in the memory according to the detected number information; and e) accessing the mobile game server over the wireless channel and downloading the resultant game score stored in the memory.

In accordance with yet another aspect of the present invention, there is provided an system for interacting with an online/offline game, comprising: a mobile terminal for downloading a game that is executable in an offline mode, playing the downloaded game, transmitting update information including number information of the mobile terminal and a resultant game score over a wireless channel; an authentication server for receiving the update information, and determining whether an access request of the mobile terminal associated with the number information of the update information is permitted according to registration authentication information of the mobile terminal; a mobile game server for accessing the mobile terminal transmitting the update information over a channel, and determining whether the resultant game score is updated according to the determination result of the authentication server; and a mobile DB (DataBase) server for updating the resultant game score associated with the mobile terminal in a predetermined table storing entry data, if it is determined that the resultant game score is updated.

In accordance with yet a further another aspect of the present invention, there is provided a mobile interactive game system, comprising: a mobile terminal for downloading a game that is executable in an offline mode, playing the downloaded game, and transmitting update information including number information of the mobile terminal and a resultant game score over a wireless channel in order to update; a mobile game server, which includes a memory for storing the number information of the mobile terminal and the resultant game score corresponding to the number information, for storing the resultant game score associated with the number information included in the update information received from the mobile terminal in the memory, and transmitting the update information; and an online game server for providing a user with a communication service needed to execute the game in an online mode, detecting the resultant game score from the update information transferred from the mobile game server, determining whether a registration character associated with the resultant game score is found, and recording the resultant game score in the registration character if it is determined that the registration character has been found; wherein the mobile game server connects the mobile terminal with the online game server.

The interactive game system and method according to the present invention downloads a game in an online mode, plays the game in an offline mode, updates the resultant game score in the mobile game server, and successively plays the game in the online mode using the resultant game score stored in the mobile game server, such that it plays the game interactively with the online and offline modes. Further, the present invention determines whether the resultant game score has been successfully stored in the mobile game server upon receipt of update result information indicating success or failure of storing the resultant game score, such that it can more easily perform a selection command to be entered after transferring the resultant game score.

### BRIEF DESCRIPTION OF THE DRAWINGS

The above and other objects, features, and advantages of the present invention will be more clearly understood from the following detailed description taken in conjunction with the accompanying drawings, in which:

FIG. 1 illustrates a system for interacting with an online/offline game using a mobile terminal in accordance with a preferred embodiment of the present invention;

FIG. 2 is an exemplary format of update information transferred from the mobile terminal illustrated in FIG. 1 in accordance with the present invention;

FIG. 3 illustrates an operation panel as illustrated in FIG. 1 having a plurality of functions associated with a game in accordance with the present invention;

FIG. 4 is an example of an initial screen image of a game displayed on the mobile terminal when a user enters a game mode using the operation panel in accordance with the present invention;

FIG. 5 is an exemplary menu screen displayed on the mobile terminal when the user selects a menu button from among the operation panel while playing the game in accordance with the present invention;

FIG. 6 is an example of a game score displayed on the mobile terminal when the SEND button illustrated in FIG. 5 is selected by the user in accordance with the present invention;

FIG. 7 is an example of a specified menu used for selecting an item to be transmitted when the ENTER button illustrated in FIG. 6 is selected by the user in accordance with the present invention;

FIG. 8 is an example of the list of servers displayed on the mobile terminal in order to select a specific server for storing the resultant game score of the selected item illustrated in FIG. 7 in accordance with the present invention;

FIGS. 9A-9B illustrate exemplary screens for indicating success or failure of the update of the resultant game score displayed on the mobile terminal upon receipt of game result information in accordance with the present invention;

FIG. 10 is a flow chart illustrating a method for interacting with an online/offline game using a mobile terminal in accordance with a preferred embodiment of the present invention;

FIG. 11 is a flow chart illustrating a procedure for sending update result information illustrated in FIG. 10;

FIG. 12 is a flow chart illustrating a procedure for updating the resultant score of a game illustrated in FIG. 10;

FIG. 13 is a flow chart illustrating a procedure for applying the resultant score of the game illustrated in FIG. 10;

FIG. 14 illustrates a system for interacting with an online/offline game using a mobile terminal in accordance with another preferred embodiment of the present invention;

FIG. 15 is a flow chart illustrating a method for interacting with an online/offline game using a mobile terminal in accordance with another preferred embodiment of the present invention;

FIG. 16 illustrates a system for interacting with an online/offline game using a mobile terminal in accordance with yet another preferred embodiment of the present invention;

FIG. 17 is an example of a menu screen displayed on the mobile terminal when a user selects a menu button while playing a game using the mobile terminal illustrated in FIG. 16; and

FIG. 18 is a flow chart illustrating a system for interacting with an online/offline game using a mobile terminal in accordance with yet another preferred embodiment of the present invention.

### DETAILED DESCRIPTION OF THE PREFERRED EMBODIMENTS

Preferred embodiments of the present invention will be described in detail herein below with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

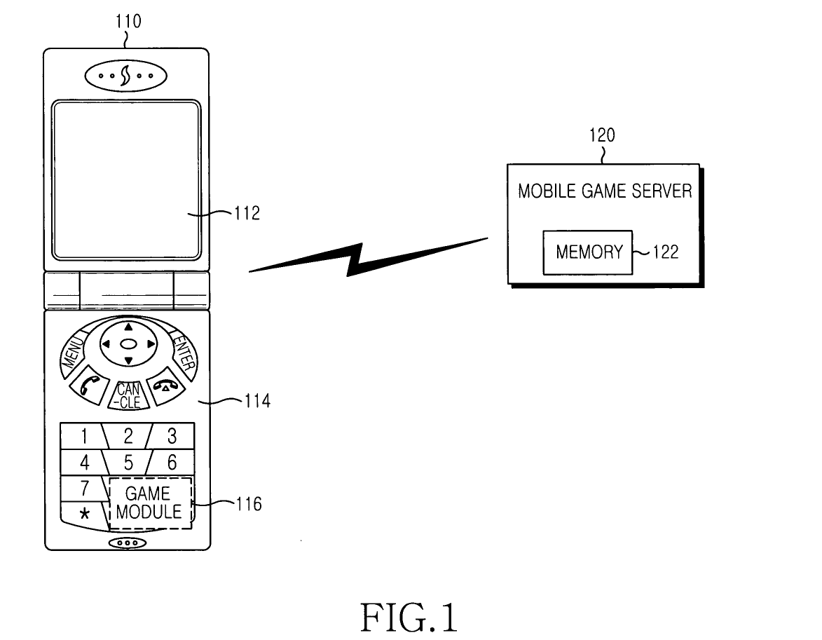

FIG. 1 illustrates a system for interacting with an online/offline game using a mobile terminal in accordance with a preferred embodiment of the present invention. Referring to FIG. 1, the system for interacting with the online/offline games includes a mobile terminal 110 for playing a game using a game module 116 located within the mobile terminal, and a mobile game server 120 for providing the mobile terminal 110 with game information.

The mobile terminal 110 downloads a game that is executable in an offline mode (i.e., an offline game) over a communication channel, and plays the downloaded game upon receipt of a game start command signal. The mobile terminal 110 transmits update information including a resultant score of the played game and number information of the mobile terminal 110 to the mobile game server 120 over a wireless channel, upon receipt of an update command signal.

The mobile game server 120 includes a memory or storage medium 122 for storing the number information of the mobile terminal 110 and the resultant game score corresponding to the number information. The mobile game server 120 receives update information from the mobile terminal 110, and detects the number information of the mobile terminal 110 from among the received update information. The mobile game server 120 stores the resultant game score contained in the update information in the memory 122 according to the detected number information. In this case, the mobile game server 120 communicates with peripheral devices in an online mode, and transmits the resultant game score stored in the memory 122 upon receipt of a signal requested by the peripheral devices. Therefore, the user can successively play a desired game in the online mode using the resultant game score stored in the mobile game server 120.

Upon receiving a command for downloading the resultant game score in the mobile game server 120 from the user, the mobile terminal 110 accesses the mobile game server 120 over a wireless channel according to a download command signal, and downloads the resultant game score stored in the memory 122 of the mobile game server 120.

Therefore, the mobile terminal downloads a game in the online mode, plays the game in the offline mode, updates the resultant game score to the mobile game server 120, and successively plays the game in the online mode using the resultant game score, such that it can interact with the game in the online/offline modes.

Preferably, if the mobile game server 120 detects the number information of the mobile terminal 110 before storing the resultant game score, it determines whether the detected number information is already stored in the memory 122. If it is determined that the detected number information has been stored in the memory 122, the mobile game server 120 updates the resultant game score to the memory 122 according to the stored number information. If it is determined that the detected number information has not been previously stored in the memory 122, the mobile game server 120 registers the detected number information in the memory 122, and stores the resultant game score in the memory 122 according to the registered number information.

Preferably, the mobile game server 120 transmits update result information for indicating success or failure of storing the resultant game score in the memory 122 to the mobile terminal 110. Therefore, the mobile terminal 110 receives the update result information from the mobile game server 120, and analyzes the received update result information. If it is determined that the resultant game score has been successfully stored in the memory 122, the mobile terminal 110 stores the game status information other than the resultant game score having been transferred to the mobile game server 120 in the game module 116. If it is determined that the resultant game score has not been successfully stored in the memory 122 according to the analyzed result of the update result information, the mobile terminal 110 stores the game status information including the resultant game score having been transferred to the mobile game server 120 in the game module 116.

Additionally, if it is determined that the resultant game score has not been successfully stored in the memory 122 according to the analyzed result of the update result information, it is preferable for the mobile terminal 110 to display a message indicating a storage failure of the resultant game score on the display screen 112 for indicating operation states of the mobile terminal 110.

Therefore, the mobile terminal 110 determines whether the resultant game score has been successfully stored in the mobile game server 120 upon receipt of update result information indicating success or failure of a memory function of the resultant game score, and easily performs a selection command to be entered after transferring the resultant game score.

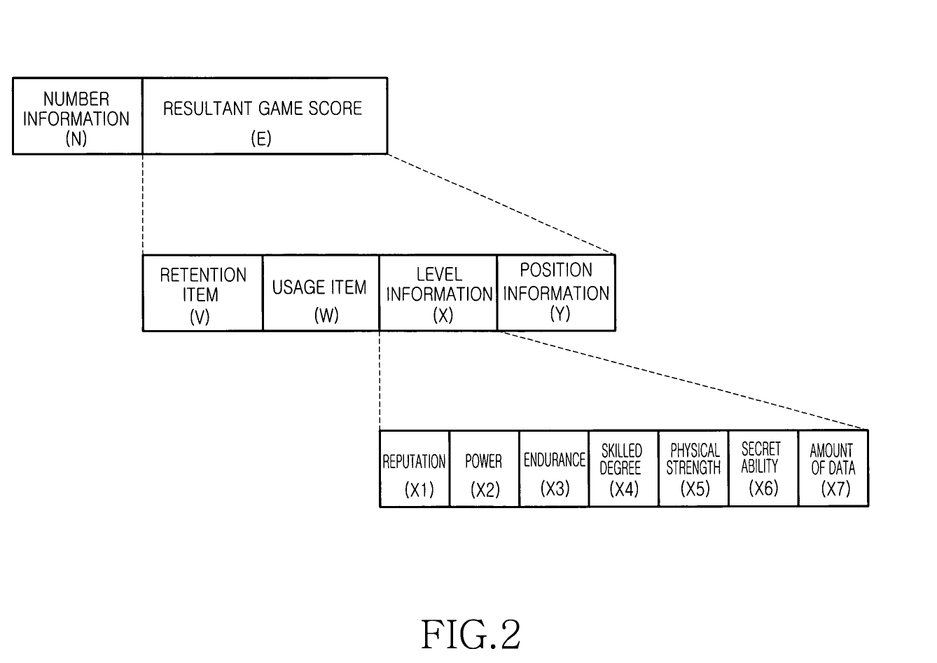

FIG. 2 is an exemplary format of update information transferred from the mobile terminal illustrated in FIG. 1 in accordance with the present invention. Referring to FIG. 2, the update information includes number information N of the mobile terminal 110, and resultant game information E (i.e., a resultant game score). The resultant game score E includes a retention item V and a usage item W of a prescribed character of the game, level information X indicating ability of the character, and position information Y of the character. In this case, the level information X may include a variety of factors, for example, reputation information X1, power or force information X2, endurance or patience information X3, skill degree information X4, physical strength information X5, secret ability X6, amount of data X7 of the character, etc.

The mobile terminal controls the resultant game score E upon receiving an entry command signal from the external key panel 114, and transmits the controlled resultant game score E to the mobile game server 120.

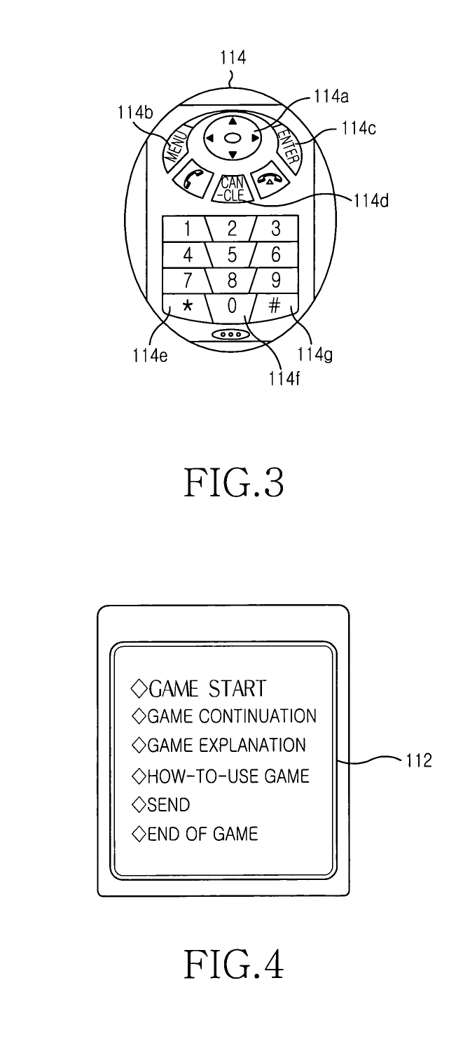

FIG. 3 illustrates the key panel 114 illustrated FIG. 1 having a plurality of functions associated with a game in accordance with the present invention. Referring to FIG. 3, the key panel 114 includes a plurality of buttons, for example, direction buttons 114a, a MENU button 114b, an ENTER button 114c, a CANCEL button 114d, a star(*) button 114e, a zero button 114f, a pound(#) button 114g, etc. The direction buttons 114a move a character or select a display menu. Pressing the MENU button 114b provides a user with a prescribed menu for selecting a predetermined command while playing the game. The ENTER button 114c is used to enter either a selection command for a corresponding function while in the game or a state information window such as a map window displayed while in the game. The CANCEL button 114d is used to move an upper menu or cancel a corresponding command. The star button 114e, the zero button 114f, and the pound button 114g are used in the state information window entered by pressing the ENTER button 114c. In this case, the star button 114e is used to select a previous menu, the zero button 114f is used to close a displayed menu and terminate a displayed information window. The pound button 114g is used to select the next menu of the displayed menu.

FIG. 4 is an example of an initial screen image of a game displayed on the screen 112 when a user enters a game mode using the key panel 114 illustrated in FIG. 3 in accordance with the present invention. Referring to FIG. 4, the initial screen image includes a plurality of menu selections, for example, a GAME START command, a GAME CONTINUATION command, a GAME EXPLANATION command, a HOW-TO-USE GAME command, a SEND command, and an END OF GAME command. In more detail, the START command is used to begin a game, the GAME CONTINUATION command is used to continuously play a specific game having previously been played, the GAME EXPLANATION command is used to describe overall contents of a specific game, the HOW-TO-USE GAME command is used to describe necessary operations for playing a specific game, the SEND command is used to transmit the resultant game score of a stored game to the mobile game server 120, and the END OF GAME command is used to terminate the initial menu of the entered game.

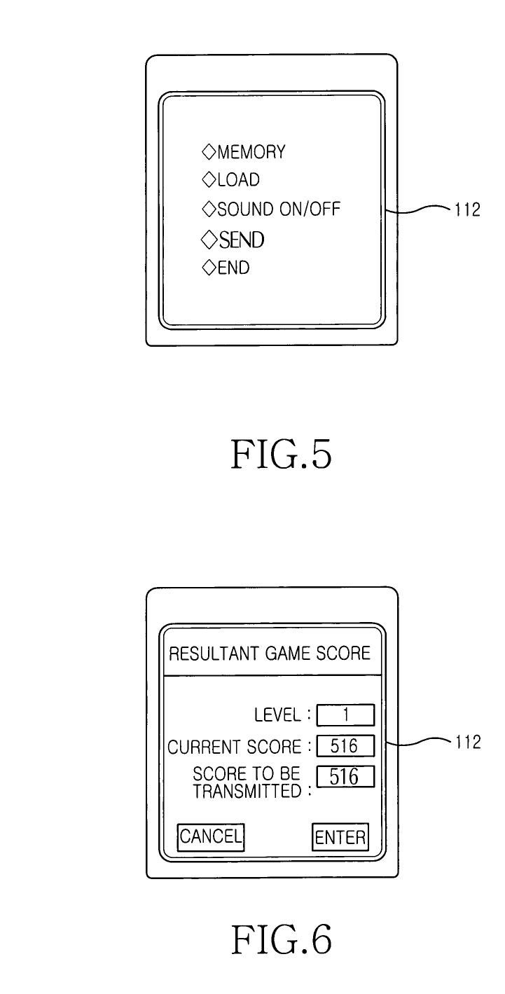

FIG. 5 is an exemplary menu screen 112 displayed on the mobile terminal when the user selects the MENU command 114b from among the key panel 114 while playing the game in accordance with the present invention. Referring to FIG. 5, the menu screen 112 includes a plurality of selections, for example, a MEMORY command, a LOAD command, a SOUND ON/OFF command, a SEND command, and an END command. In more detail, the MEMORY command is used to store the resultant game score of a game in progress, the LOAD command is used to load the resultant game score stored in the mobile terminal 110, the SOUND ON/OFF command is used to switch the sound on or off while in the game, the SEND command is used to transmit the resultant game score to the mobile game server 120, and the END command is adapted to terminate the game.

FIG. 6 is an example of the game score displayed on the screen 112 of the mobile terminal 110 when the SEND command illustrated FIG. 5 is selected by the user in accordance with the present invention. Referring to FIG. 6, the LEVEL command is used to indicate a character level of a current game, the CURRENT SCORE command is used to indicate a score of a character acquired based on the result of the game, the SCORE TO BE TRANSMITTED command is used to select and enter a score to be transmitted to the mobile game server 120 from among the current score, the CANCEL command is used to move an upper menu of the displayed menu, and the ENTER command is used to select a controlled score to be transmitted.

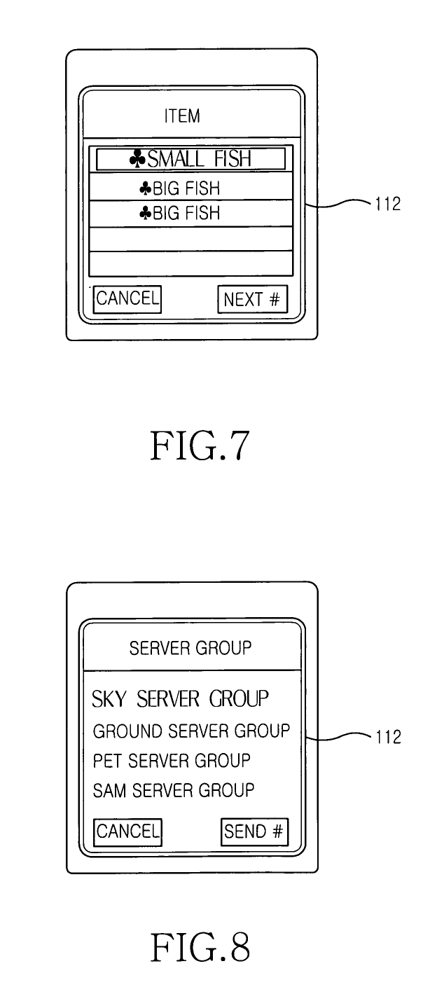

FIG. 7 is an example of a specified menu used for selecting an item to be transmitted when the ENTER command illustrated in FIG. 6 is selected by the user in accordance with the present invention. It should be noted that the SMALL FISH item is exemplarily selected from among a plurality of selections illustrated in FIG. 7.

FIG. 8 is an example of the list of servers displayed on the mobile terminal in order to select a specific server for storing the resultant game score of the selected item illustrated in FIG. 7 in accordance with the present invention. It should be noted that the SKY SEVER GROUP selection is exemplarily selected from among a plurality of selections illustrated in FIG. 8. This indicates that the SKY SERVER GROUP is an example of the mobile game server 120. Update information containing the resultant game score is transmitted to the SKY SERVER GROUP serving as a mobile game server 120. The SKY SERVER GROUP stores the resultant game score corresponding to the number information of the mobile terminal 110, and transmits update result information indicating the storage result to the mobile terminal 110. The mobile terminal 110 applies the resultant game score according to the resultant game score transmitted from the SKY SERVER GROUP.

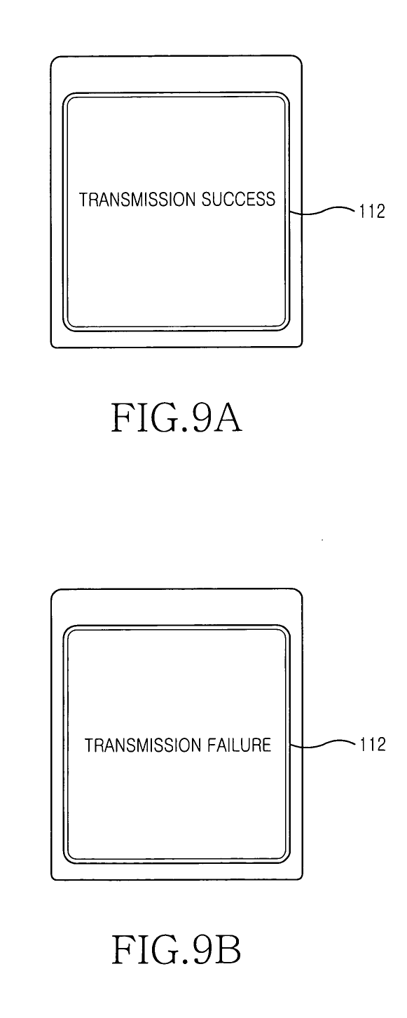

FIGS. 9A-9B are views illustrating exemplary screens 112 for indicating success or failure of the update of the resultant game score displayed on the mobile terminal 110 upon receipt of game result information in accordance with the present invention. Referring to FIGS. 9A-9B, if it is determined that the resultant game score has been successfully updated to the mobile game server 120 according to the analyzed result of the received update information, the mobile terminal 110 displays a predetermined message “TRANSMISSION SUCCESS” on the screen 112. Otherwise if it is determined that the resultant game score has not been successfully updated according to the analyzed result of the received update information, the mobile terminal 110 displays a predetermined message “TRANSMISSION FAILURE” on the screen 112.

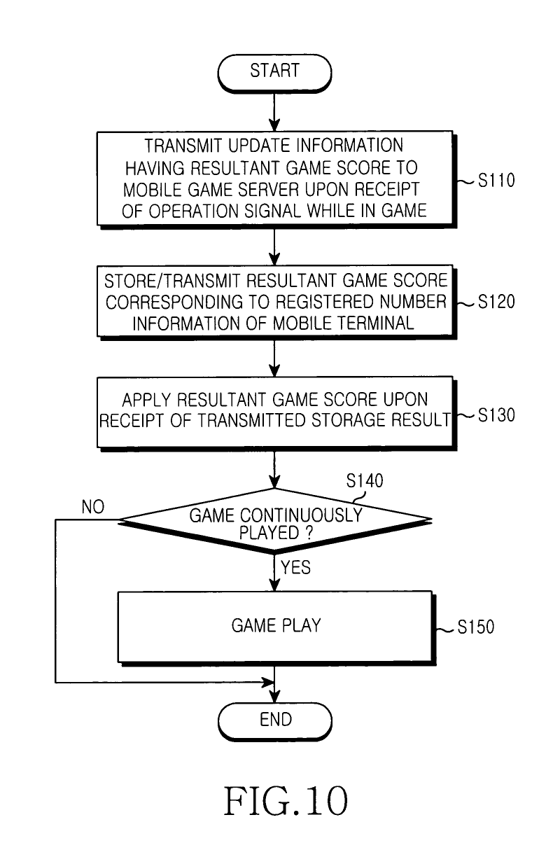

FIG. 10 is a flow chart illustrating a method for interacting with an online/offline game using a mobile terminal in accordance with a preferred embodiment of the present invention. Referring to FIG. 10, the mobile terminal 110 transmits update information including the resultant game score to the mobile game server 120 according to an operation signal entered during a game at step S110. Next, the mobile game server 120 receives update information from the mobile terminal 110, and stores the resultant game score contained in the received update information according to registration number information corresponding to the mobile terminal 110 at step S120. The mobile game server 120 transmits the update result information indicating the success of the storage result of the resultant game score to the mobile terminal 110.

In this case, the mobile game server 120 communicates with a specific external device in an online mode, and receives a predetermined request signal from the external device, such that it can transmit the resultant game score having been stored in the memory 122 to the external device upon receipt of the request signal. Therefore, the user can continuously play a desired game in the online mode using the resultant game score having been stored in the mobile game server 120.

The mobile terminal 110 analyzes success or failure of the update of the resultant game score upon receiving update result information from the mobile game server 120, and applies the resultant game score upon receipt of the analyzed result at step S130. The mobile terminal 110 determines whether a predetermined command for continuously playing a game having been suspended is entered to transmit the resultant game score to the mobile game server 120 at step S140. If it is determined that the predetermined command for continuously playing the game has been entered at step S140, the mobile terminal 110 successively plays the suspended game at step S150. However, if the predetermined command for continuously playing the game has not been entered at step S140, the game is ended.

Therefore, provided that the game is played in the offline mode and its resultant score is then transmitted to a predetermined object in the online mode, the game can be continuously played or executed in the online and offline modes.

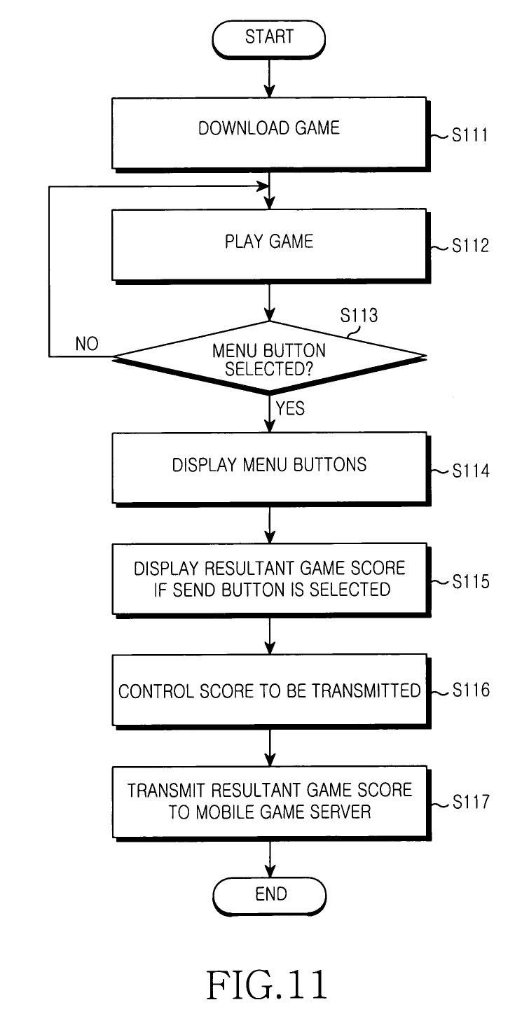

FIG. 11 is a flow chart illustrating step S110 for sending update result information illustrated in FIG. 10. Referring to FIG. 11, the mobile terminal 110 accesses an external device for providing a user with an online game, and downloads a desired game from the external device at step S11. If the downloaded game is executed by a predetermined command signal (played) at step S112, the mobile terminal 110 determines whether a predetermined signal for selecting the MENU command 114b is entered while in the game at step S113.

If it is determined that the MENU command is selected at step S1113, the mobile terminal 110 displays the menu illustrated in FIG. 5 on the screen 112 at step S114. If it is determined that the SEND command is selected from among a plurality of command illustrated in FIG. 5, the mobile terminal 110 displays the resultant game score on the screen 112 at step S115. Upon receipt of an entry transmission command signal, the mobile terminal 110 selects a specific score to be transmitted from among the resultant game score having been displayed on the screen 112, and controls the selected specific score at step S116. Upon receiving a command for sending the controlled resultant game score, the mobile terminal 110 transmits the controlled resultant game score to the mobile game server 120 over a channel at step S117.

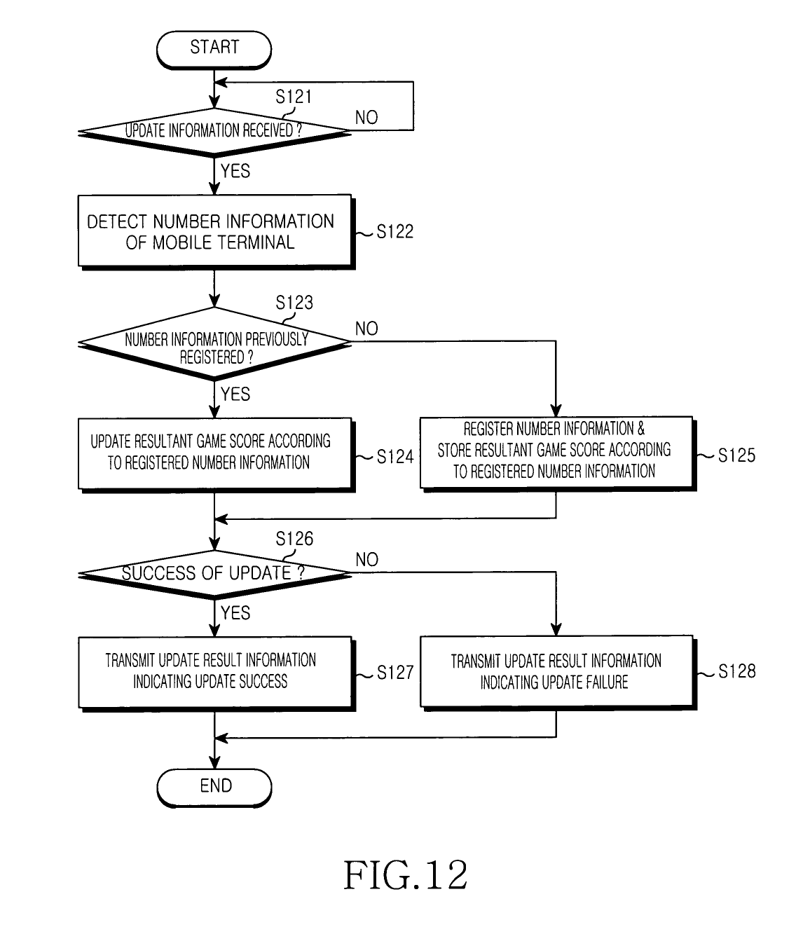

FIG. 12 is a flow chart illustrating step S120 for updating the resultant score of the game illustrated in FIG. 10. Referring to FIG. 12, it is determined whether the mobile game server 120 receives update information from the mobile terminal 110 at step S121. If it is determined that the mobile game server 120 has received the update information at step S121, the mobile game server 120 detects number information of the mobile terminal 110 upon receipt of the received update information at step S122. Next, the mobile game server 120 determines whether the detected number information has previously been registered in the memory 122 at step S123.

If the detected number information has been registered in the memory 122 at step S123, the mobile game server 120 updates the resultant game score to the memory 122 according to the registered number information at step S124. If it is determined that the detected number information has not been registered in the memory 122, the mobile game server 120 registers the detected number information in the memory 122, and stores the resultant game score in the memory 122 according to the registered number information at step S125.

Thereafter, the mobile game server 120 determines success or failure of the update of the resultant game score included in the received update information at step S126. If it is determined that the resultant game score has been successfully updated at step S126, the mobile game server 120 transmits update result information containing information indicating successful update of the resultant game score to the mobile terminal 110 at step S127. However, if it is determined that the resultant game score has not been successfully updated at step S126, the mobile game server 120 transmits update information containing information indicating update failure of the resultant game score to the mobile terminal 110 at step S128.

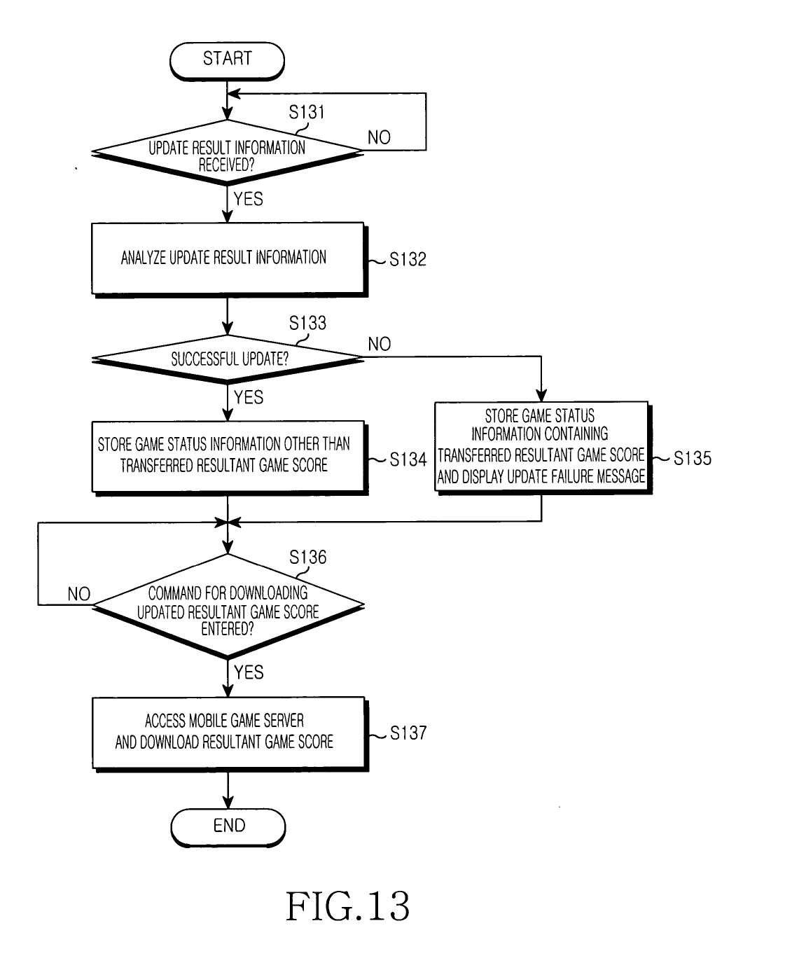

FIG. 13 is a flow chart illustrating step S130 for applying the resultant game score illustrated in FIG. 10. Referring to FIG. 13, at step S131, it is determined whether the mobile terminal 110 has received update result information from the mobile game server 120. Upon receipt of the update result information, the mobile terminal 110 analyzes information indicating success or failure of the information update operation on the basis of received update result information at step S132. Therefore, the mobile terminal 110 determines success or failure of the information update operation upon receipt of the analyzed information at step S133. If the success of information update operation has been determined at step S133, game status information other than the transmitted resultant game score is stored in the game module 116 at step S134. However, if the failure of information update operation has been determined at step S133, the mobile terminal 110 stores game status information including the transmitted resultant game score in the game module 116 at step S135. Further, if the failure of the information update operation has been determined at step S133, the mobile terminal 110 displays a specified message “Transmission Failure” indicating the failure of the information update operation on the screen 112.

At step S136, the mobile terminal 110 sets up the resultant game score, and then determines whether a command for downloading the resultant game score having been updated in the mobile game server 120 has been received. If it is determined the command for downloading the resultant game score has been transmitted to the mobile terminal 110 at step S136, the mobile terminal 110 accesses the mobile game server 120, and downloads the resultant game score stored in the memory 122 at step S137. As a result, the user can play a desired game with the resultant game score operable in online and offline modes.

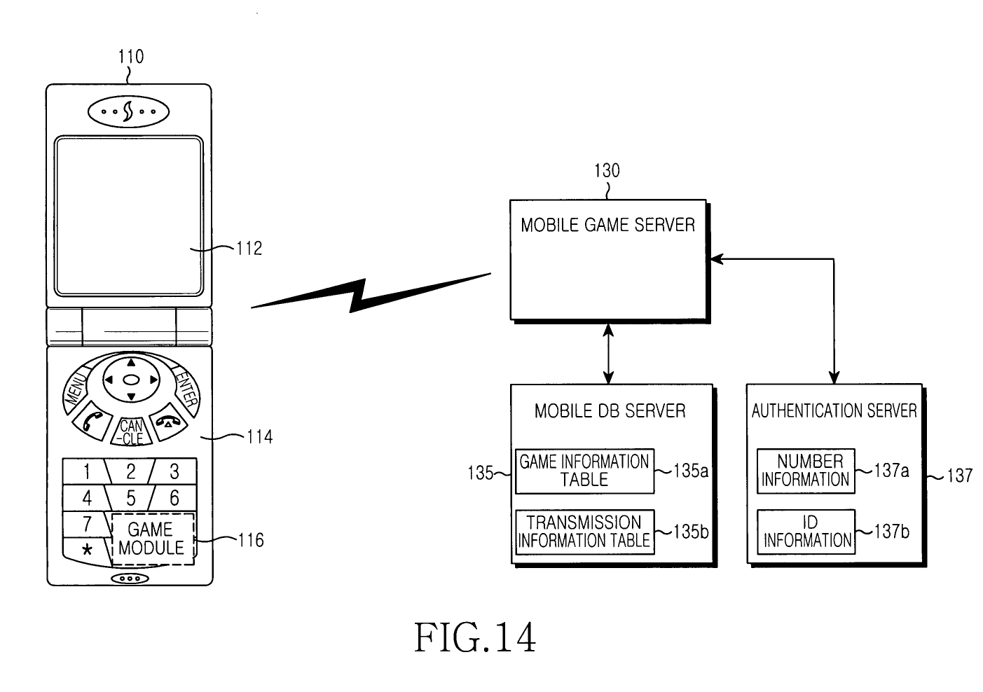

FIG. 14 illustrates a system for interacting with online/offline games using the mobile terminal in accordance with another preferred embodiment of the present invention. Referring to FIG. 14, the system for interacting with online/offline games includes a mobile terminal 110, a mobile game server 130, a mobile database (DB) server 135, and an authentication server 137.

The mobile terminal 110 downloads a game that is executable in an offline mode from a predetermined server over a communication channel, and plays the downloaded game upon receipt of a game start command signal. Upon receipt of an update command signal, the mobile terminal 110 transmits update information including number information of the mobile terminal 110 and the resultant game score of the played game to the mobile game server 130 over a wireless channel.

Upon receiving the update information from the mobile terminal 110, the mobile game server 130 detects the number information of the mobile terminal 110 from the received update information, and transmits the detected number information to the authentication server 137. The mobile DB server 135 includes a table for storing data having been transmitted from the mobile game server 130. The authentication server 137 includes number information 137a of the mobile terminal 110 and registration ID information 137b corresponding to the number information 137a. Therefore, the authentication server 137 receives the number information of the mobile terminal 110 from the mobile game server 130, determines presence or absence of ID information corresponding to the received number information, and determines whether it permits an access request of the mobile terminal 110. If the presence of the ID information corresponding to the number information transferred from the mobile game server 130 has been determined, the authentication server 137 transmits registration ID information corresponding to the number information to the mobile game server 130.

If it is determined that the authentication server 137 contains no number information of the mobile terminal 110, the mobile game server 130 can register number information of the mobile terminal 110, and can transmit a predetermined signal for requesting ID information corresponding to the registered number information to the mobile terminal 110. Upon receiving user ID information having been entered by a user from the mobile terminal 110, the mobile game server 130 controls the authentication server 137 to store the received ID information according to number information of the registered mobile terminal 110.

The table contained in the mobile DB server 135 includes a game information table 135a and a transmission information table 135b. The game information table 135a stores game information of games that are executable in the mobile terminal 110.

The transmission information table 135b includes number information of the mobile terminal 110, registration ID information corresponding to the number information of the mobile terminal 110, and the resultant game score contained in update information transferred from the mobile terminal 110.

If the number information of the mobile terminal 110 and registration ID information corresponding to the number information have been contained in the authentication server 137, the mobile game server 130 controls the mobile DB server 135 to store the resultant game score contained in the update information in the transmission information table 135b. The resultant game score transmitted from the mobile terminal 110 is the same as described in the first preferred embodiment of the present invention.

The mobile game server 130 determines whether the resultant game score has been successfully stored in the transmission information table 135b of the mobile DB server 135, and transmits update result information indicating its determination result to the mobile terminal 110.

Therefore, the mobile terminal 110 analyzes the success or failure of the update of the resultant game score upon receiving the update result information from the mobile game server 130. If it is determined that the resultant game score has been successfully updated in the mobile DB server 135, the mobile terminal 110 stores game status information except for the resultant game score having been transferred to perform the update of information in the game module 116. If it is determined that the resultant game score has not been successfully updated in the mobile DB server 135 according to the analyzed result of update result information, the mobile terminal 110 stores game status information including the resultant game score having been transferred to perform the update of information in the game module 116. Preferably, if it is determined that the resultant game score has not been successfully stored in the mobile DB server 135 according to the analyzed result of the update result information, a predetermined message indicating the update failure of the resultant game score can be displayed on the screen 112 indicating operation states of the mobile terminal 110.

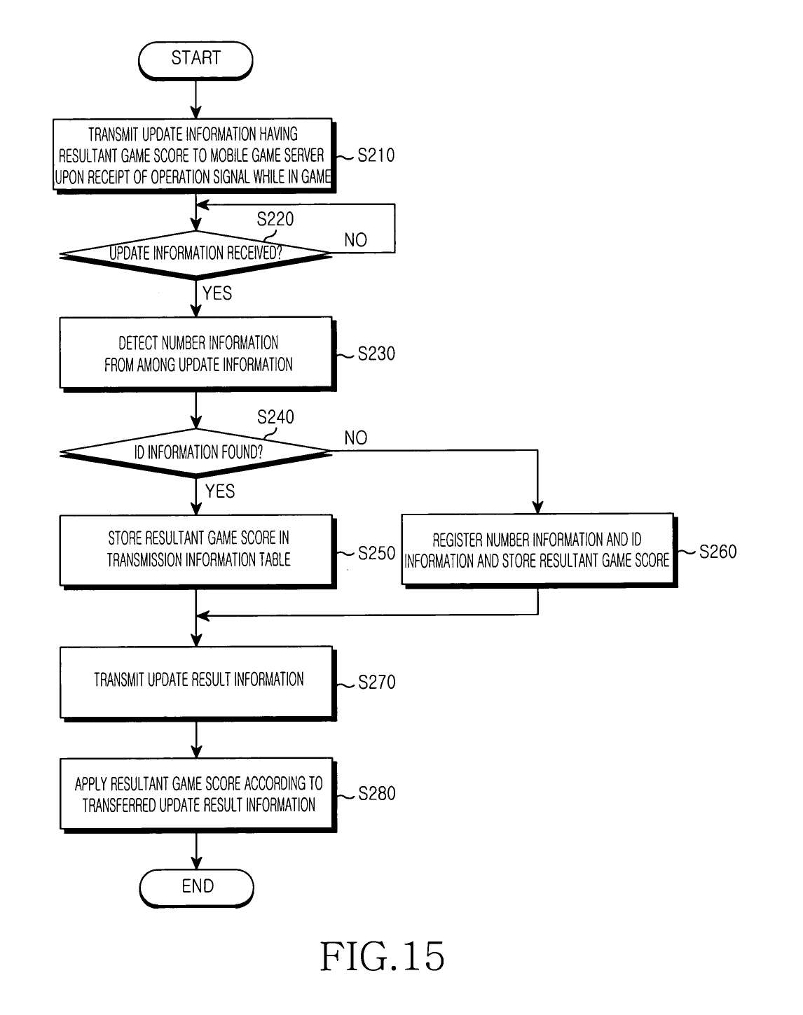

FIG. 15 is a flow chart illustrating a method for interacting with an online/offline game using the mobile terminal in accordance with another preferred embodiment of the present invention. Referring to FIG. 15, the mobile terminal 110 transmits update information including number information of the mobile terminal 110 and the resultant game score to the mobile game server 130 according to an operation signal entered during the game at step S210. The mobile game server 130 determines whether it has received update information transferred from the mobile terminal 110 at step S220. If the mobile game server 130 has determined the reception of update information at step S220, it detects the number information from the received update information, and transmits the detected number information to the authentication server 137 at step S230.

Upon receiving the number information from the mobile game server 130, the authentication server 137 determines whether registration number information and ID information corresponding to the registration number information are found at step S240. If it is determined that the ID information associated with the number information have been found at step S240, the mobile game server 130 controls the mobile DB server 135 to store the resultant game score in the transmission information table 135b at step S250. However, if it is determined that the ID information corresponding to the number information is not found at step S240, the mobile game server 130 registers the received number information and ID information, and stores the resultant game score corresponding to the registered ID information at step S260.

The mobile game server 130 transmits update result information indicating the success or failure of updating the resultant game score of the received update information to the mobile terminal 110 at step S270. Upon receipt of update result information transmitted from the mobile game server 130, the mobile terminal 110 applies the resultant game score to game status information according to the received update result information at step S280.

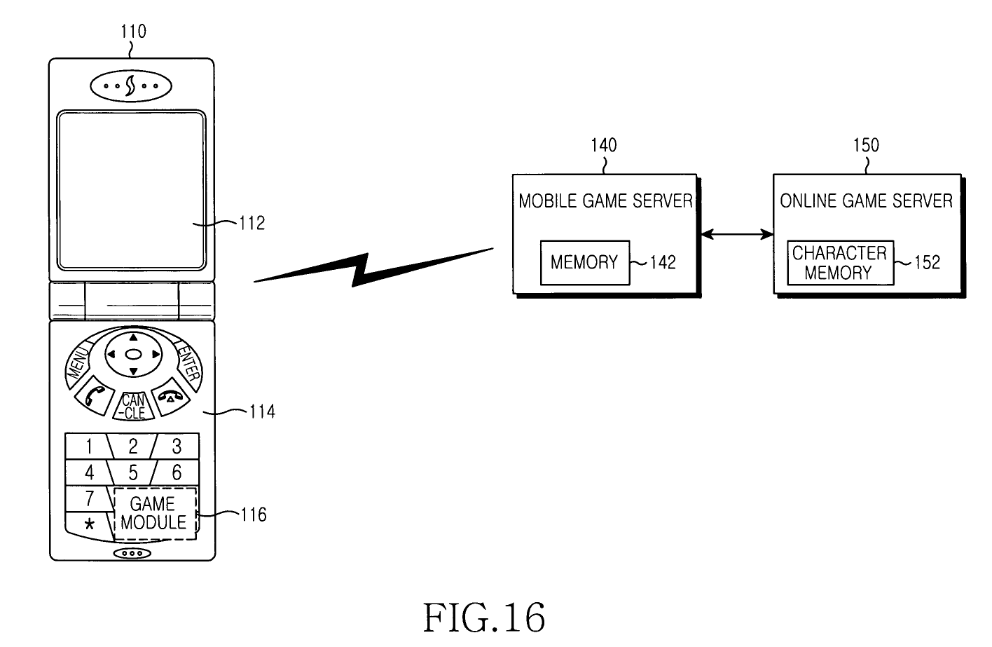

FIG. 16 illustrates a system for interacting with an online/offline game using the mobile terminal in accordance with yet another preferred embodiment of the present invention. Referring to FIG. 16, the system for interacting with online/offline games includes a mobile terminal 110, a mobile game server 140, and an online game server 150. The mobile terminal 110 downloads a game that is executable in an offline mode from a predetermined server over a communication channel, and plays the downloaded game according to an entry command signal. Upon receipt of a predetermined key signal having been entered to update necessary information in the online game server 150, the mobile terminal 110 transmits update information including number information of the mobile terminal 110 and the resultant game score of the played game to the mobile game server 140 over a wireless channel.

Upon receiving the update information from the mobile terminal 110, the mobile game server 140 stores the resultant game score having been included in the received update information in the memory 142 according to the number information of the mobile terminal 110. The mobile game server 140 transmits the received update information having been transferred from the mobile terminal 110 to the online game server 150.

The online game server 150 applies or records the resultant game score included in the update information having been received from the mobile game server 140 to a character having been stored in the character memory 152 storing characters selected by an entry command signal. The online game server 150 determines whether the resultant game score of the update information having been received from the online game server 150 has been successfully applied or recorded in the character, and transmits update result information indicating the result of the character application to the mobile game server 140.

The mobile game server 140 records the resultant game score having been stored in the memory 142 upon receiving the update result information from the online game server 150, and transmits update result information to the mobile terminal 110. The mobile terminal 110 records the resultant game score having been transferred to perform the update of information upon receiving game result information from the mobile game server 140.

Preferably, the mobile game server 140 analyzes the update result information, and determines whether the resultant game score has been successfully recorded in the character having been stored in the character memory 152. If it is determined that the resultant game score has been successfully recorded in the character, the mobile game server 140 transmits a message indicating the success of reflecting the resultant game score to the mobile terminal 110. If it is determined that the resultant game score has not been successfully recorded in the character, the mobile game server 140 transmits a predetermined message indicating the failure of reflecting the resultant game score to the mobile terminal 110. Therefore, if the mobile terminal 110 has received the message indicating the success of reflecting the resultant game score from the mobile game server 140, it stores game status information except for the transmitted resultant game score in the game module 116. However, if the mobile terminal 110 has received a message indicating the failure of reflecting the resultant game score from the mobile game server 140, it stores game status information including the transmitted resultant game score in the game module 116. Preferably, if the mobile terminal 110 receives the message indicating the failure of reflecting the resultant game score, it displays a predetermined message indicating the failure of updating the resultant game score on the screen 112 indicating operation states of the mobile terminal 110.

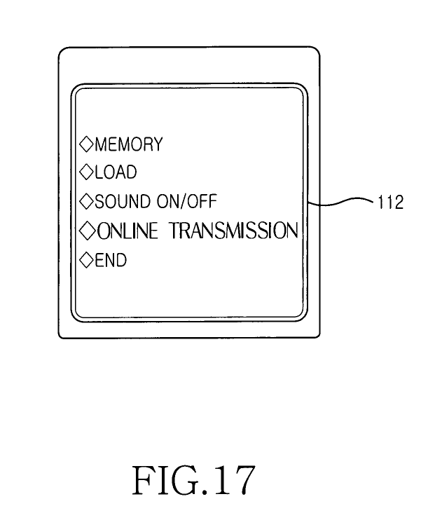

FIG. 17 is an exemplary menu screen 112 displayed on the mobile terminal 110 when a user selects the MENU button 114b while playing a game using the mobile terminal 110 illustrated in FIG. 16. Referring to FIG. 17, the menu screen 112 includes a plurality of command selections, for example, a MEMORY command, a LOAD command, a SOUND ON/OFF command, an ONLINE SEND command, and an END command. In more detail, the MEMORY command is used to store status information of a suspended game upon receipt of a predetermined signal for selecting the MENU button 114b, the LOAD command is used to load the resultant game score having been stored in the mobile terminal 110, the SOUND ON/OFF command is used to switch the sound on or off while in the game, the ONLINE SEND command is used to transmit the resultant score of a game in progress to the mobile game server 150, and the END command is used to terminate the game.

It should be noted that the ONLINE SEND command is exemplarily selected from among the plurality of commands illustrated in FIG. 17. Therefore, if the ONLINE SEND command is selected, the mobile terminal 110 transmits update information including the resultant game score to the mobile game server 140, and the mobile game server 140 transmits the received update information to the online game server 150.

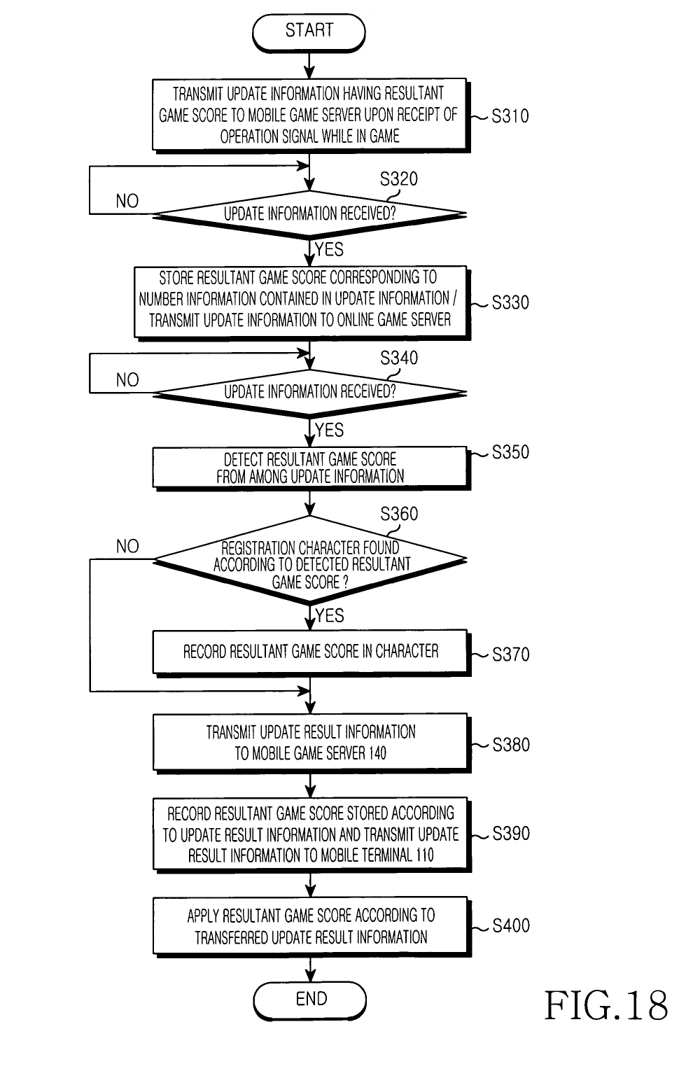

FIG. 18 is a flow chart illustrating a system for interacting with an online/offline game using a mobile terminal in accordance with yet another preferred embodiment of the present invention. Referring to FIG. 18, the mobile terminal 110 transmits update information including number information of the mobile terminal 110 and the resultant game score to the mobile game server 150 according to a key signal entered while in the game, at step S310, such that the update information is updated in the online game server 150. The mobile game server 140 determines whether the update information transferred from the mobile terminal 110 has received at step S320. If the mobile game server 140 determines the reception of update information at step S320, it detects number information from the received update information, and stores the resultant game score in the memory 142 according to the detected number information at step S330. The mobile game server 140 transmits the received update information to the online game server 150.

The online game server 150 determines whether update information transferred from the mobile game server 140 has received at step S340. If the reception of update information has been determined, the online game server 150 detects the resultant game score from the update information at step S350. In this case, the online game server 150 determines whether a registration character associated with the detected resultant game score is found in the character memory 152 at step S360. If it is determined that the registration character associated with the resultant game score has been found in the character memory 152, the online game server 150 records the resultant game score in the character having been registered in the character memory 152 at step S370.

After recording the resultant game score in the character, the online game server 150 transmits update result information indicating the success or failure of recording the resultant game score in the character to the mobile game server 140 at step S380. Upon receiving the update result information from the online game server 150, the mobile game server 140 applies the resultant game score having been stored in the memory 142 to the game according to the received update result information at step S390.

The mobile game server 140 transmits the received update result information to the mobile terminal 110. If it is determined that the resultant game score has been successfully recorded in the character on the basis of the analyzed result of the update result information, the mobile game server 140 can transmit a message indicating the success of recording the resultant game score in the character to the mobile terminal 110. However, if it is determined that the resultant game score has not been successfully reflected in the character on the basis of the analyzed result of update result information, the mobile game server 140 can transmit a message indicating the failure of recording the resultant game score in the character to the mobile terminal 110.

The mobile terminal 110 applies the resultant game score stored in the game module 116 according to the update result information having been transferred from the mobile game server 140 at step 400. Upon receipt of the message indicating the record success from the mobile game server 140, the mobile terminal 110 stores the game status information other than the transmitted resultant game score in the game module 116. Upon receipt of the other message indicating the record failure, the mobile terminal 110 stores game status information containing the transmitted resultant game score in the game module 116. Upon receipt of the message indicating the record failure, the mobile terminal 110 displays the received message indicating the failure of reflection on the screen 112 indicating operation states of the mobile terminal 110. Accordingly, the user can continuously play a desired game in the online mode using the resultant game score stored in the mobile game server 140.

As is apparent from the above description, the interactive game system and method according to the present invention downloads a game in an online mode, plays the game in an offline mode, updates the resultant game score in the mobile game server, and successively plays the game in the online mode using the resultant game score stored in the mobile game server, such that it plays the game interactively with the online and offline modes.

Furthermore, the present invention determines whether the resultant game score has been successfully stored in the mobile game server upon receipt of update result information indicating the success or failure of storing the resultant game score, such that it can easily perform a selection command to be entered after transferring the resultant game score.

Although preferred embodiments of the present invention have been disclosed for illustrative purposes, those skilled in the art will appreciate that various modifications, additions, and substitutions are possible, without departing from the scope and spirit of the invention as disclosed in the accompanying claims.

What is claimed is:

1. A system for interacting with an online/offline game, comprising:
a mobile terminal for downloading a game that is executable in an offline mode over a communication channel, playing the downloaded game, and transmitting update information including number information of the mobile terminal and a resultant game score over a wireless channel; and
a mobile game server, which includes a memory for storing the number information of the mobile terminal and the resultant game score corresponding to the number information, for detecting the number information of the mobile terminal from among the received update information upon receiving the update information from the mobile terminal, and storing the resultant game score in the memory according to the detected number information;
wherein the mobile terminal accesses the mobile game server over the wireless channel upon receipt of an entry command signal, and downloads the resultant game score stored in the mobile game server.

2. The system as set forth in claim 1, wherein the mobile game server determines whether the detected number information of the mobile terminal is contained in the memory, updates the resultant game score in the memory according to the stored number information, if the detected number information is contained in the memory, and registers the detected number information in the memory and stores the resultant game score in the memory according to the registered number information, if the detected number information is not contained in the memory.

3. The system as set forth in claim 2, wherein the mobile game server transmits update result information for indicating a success of storing the resultant game score in the memory to the mobile terminal.

4. The system as set forth in claim 3, wherein the mobile terminal receiving the update result information from the mobile game server stores game status information not including the transferred resultant game score, if it is determined that the resultant game score has been successfully stored in the memory on the basis of the received update result information, and stores game status information including the transferred resultant game score, if it is determined that the resultant game score has not been successfully stored in the memory on the basis of the received update result information.

5. The system as set forth in claim 4, wherein the mobile terminal displays a message indicating storage failure of the resultant game score on a display screen of the mobile terminal, if it is determined that the resultant game score has not been successfully stored in the memory.

6. The system as set forth in claim 5, wherein the resultant game score includes at least one of a retention item and a usage item of a prescribed character of the game, level information indicating ability of the character, and position information of the character.

7. A method for interacting with an online/offline game utilizing a mobile terminal and a mobile game server, said mobile terminal for downloading a game that is executable in an offline mode over a communication channel, and playing the downloaded game, and said mobile game server including a memory for storing number information of the mobile terminal and a resultant game score corresponding to the number information, said method comprising the steps of:
a) transmitting update information including the resultant game score of the game played and the number information of the mobile terminal over a wireless channel upon receipt of an entry command signal;
b) receiving the update information from the mobile terminal;
c) detecting the number information of the mobile terminal from the received update information;
d) storing the resultant game score included in the update information in the memory according to the detected number information; and
e) accessing the mobile game server over the wireless channel and downloading the resultant game score stored in the memory.

8. The method as set forth in claim 7, wherein step (d) comprises the steps of:
d1) determining whether the number information detected at step (c) has previously been registered in the memory; and
d2) if it is determined that the number information has previously been registered in the memory, updating the resultant game score in the memory according to the registered number information.

9. The method as set forth in claim 8, further comprising the step of:
d3) if it is determined that the number information has not been previously registered in the memory at step (d1), registering the number information in the memory, and storing the resultant game score in the memory according to the registered number information.

10. The method as set forth in claim 9, further comprising the step of:
d4) after performing one of steps (d2) and (d3), transmitting, to the mobile terminal, update result information including predetermined information indicating a success of storing the resultant game score in the memory.

11. The method as set forth in claim 10, further comprising the steps of:
d5) receiving the update result information;
d6) detecting the information indicating the success of storing the resultant game score in the memory;
d7) if it is determined that the resultant game score has been successfully stored in the memory, storing game status information not including the transferred resultant game score; and
d8) if it is determined that the resultant game score has not been successfully stored in the memory, storing game status information including the transferred resultant game score.

12. The method as set forth in claim 11, further comprising the step of:
d9) if it is determined that the resultant game score has not been successfully stored in the memory, displaying a message indicating a storage failure of the resultant game score on a display of the mobile terminal.

13. The method as set forth in claim 12, wherein the resultant game score includes at least one of a retention item and a usage item of a prescribed character of the game, level information indicating at least one ability of the character, and position information of the character.

14. A system for interacting with an online/offline game, comprising:
a mobile terminal for downloading a game that is executable in an offline mode, playing the downloaded game, transmitting update information including number information of the mobile terminal and a resultant game score over a wireless channel;
an authentication server for receiving the update information, and determining whether an access request of the mobile terminal associated with the number information of the update information is permitted according to registration authentication information of the mobile terminal;
a mobile game server for accessing the mobile terminal transmitting the update information over a channel, and determining whether the resultant game score is updated according to the determination result of the authentication server; and
a mobile DB (DataBase) server for updating the resultant game score associated with the mobile terminal in a predetermined table storing entry data, if it is determined that the resultant game score is updated.

15. The system as set forth in claim 14, wherein the authentication information includes registration identifier (ID) information corresponding to the number information of the mobile terminal, and indicates that the access request of the mobile terminal is permitted on the basis of a presence of the registration ID information corresponding to the number information of the mobile terminal transferred from the mobile game server.

16. The system as set forth in claim 15, wherein the mobile game server, if the authentication server determines that the registration ID information associated with the mobile terminal is not contained in the authentication information, controls the authentication server to register the number information and ID information corresponding to the number information in the authentication information, and controls the mobile DB server to store the resultant game score according to the number information and the ID information registered in the authentication information.

17. The system as set forth in claim 5, wherein the resultant game score includes at least one of a retention item and a usage item of a prescribed character of the game, level information indicating at least one ability of the character, and position information of the character.

18. The system as set forth in claim 17, wherein the table includes:
a transmission information table including the number information of the mobile terminal, the registration ID information corresponding to the mobile terminal, and the resultant game score transferred from the mobile terminal; and
a game information table including game information of games that are executable in the mobile terminal.

19. The system as set forth in claim 18, wherein the mobile game server transmits update result information indicating a success of storing the resultant game score in the table of the mobile DB server to the mobile terminal.

20. The system as set forth in claim 19, wherein the mobile terminal receiving the update result information from the mobile game server stores game status information not including the transferred resultant game score, if it is determined that the resultant game score has been successfully stored in the mobile DB server on the basis of the received update result information, and stores game status information including the transferred resultant game score if it is determined that the resultant game score has not been successfully stored in the mobile DB server on the basis of the received update result information.

21. The system as set forth in claim 20, wherein the mobile terminal displays a message indicating a storage failure of the resultant game score on a display of the mobile terminal, if it is determined that the resultant game score has not been successfully stored in the mobile DB server.

22. A method for interacting with an online/offline game utilizing a mobile terminal and a mobile game server, said mobile terminal for downloading a game that is executable in an offline mode over a wireless channel, and playing the downloaded game, and said mobile game server including a memory for storing number information of the mobile terminal and a resultant game score corresponding to the number information, said method comprising the steps of:
a) transmitting update information including the resultant game score of the game played and the number information of the mobile terminal over a wireless channel;
b) receiving the update information from the mobile terminal;
c) determining whether the number information included in the received update information and registration ID information corresponding to the number information are found;
d) if it is determined that the registration ID information has been found, storing the resultant game score in a table for storing entry data; and
e) upon receiving a request signal for downloading the resultant game score stored in the table from the mobile terminal connected over the wireless channel, downloading the resultant game score stored in the table into the mobile terminal.

23. The method as set forth in claim 22, further comprising the step of:
f) if the registration ID information is not found at step (c), registering the number information and the ID information corresponding to the number information, and storing the resultant game score according to the registered number information and the ID information.

24. The method as set forth in claim 23, wherein the resultant game score includes at least one of a retention item and a usage item of a prescribed character of the game, level information indicating at least one ability of the character, and position information of the character.

25. The method as set forth in claim 24, wherein the table includes:
a transmission information table including the number information of the mobile terminal, the registration ID information corresponding to the mobile terminal, and the resultant game score transferred from the mobile terminal; and
a game information table including game information of games that are executable in the mobile terminal.

26. The method as set forth in claim 25, further comprising the step of:
g) after performing step (d), transmitting update result information including predetermined information indicating a success of storing the resultant game score in the table to the mobile terminal.

27. The method as set forth in claim 26, further comprising the steps of:
h) receiving the update result information having been transferred at step (g);
i) determining the success of storing the resultant game score in the table from the received update result information;
j) if it is determined that the resultant game score has been successfully stored in the table, storing game status information not including the transferred resultant game score in the mobile terminal; and
k) if it is determined that the resultant game score has not been successfully stored in the table, storing game status information including the transferred resultant game score in the mobile terminal.

28. The method as set forth in claim 27, further comprising the step of:
l) if it is determined that the resultant game score has not been successfully stored in the table, displaying a message indicating a storage failure of the resultant game score on a display screen of the mobile terminal.

29. A mobile interactive game system, comprising:
a mobile terminal for downloading a game that is executable in an offline mode, playing the downloaded game, and transmitting update information including number information of the mobile terminal and a resultant game score over a wireless channel in order to update;
a mobile game server, which includes a memory for storing the number information of the mobile terminal and the resultant game score corresponding to the number information, for storing the resultant game score associated with the number information included in the update information received from the mobile terminal in the memory, and transmitting the update information; and
an online game server for providing a user with a communication service needed to execute the game in an online mode, detecting the resultant game score from the update information transferred from the mobile game server, determining whether a registration character associated with the resultant game score is found, and recording the resultant game score in the registration character if it is determined that the registration character has been found;
wherein the mobile game server connects the mobile terminal with the online game server.

30. The system as set forth in claim 29, wherein the online game server determines a presence the character corresponding to the resultant game score, and transmits update result information indicating a success of recording the resultant game score in the character to the mobile game server according to the determination result; and
wherein the mobile game server analyzes the update result information, transmits a message indicating record success of the resultant game score to the mobile terminal, if it is determined that the resultant game score has been successfully recorded in the character, and transmits a message indicating record failure of the resultant game score to the mobile terminal, if it is determined that the resultant game score has not been successfully recorded in the character.

31. The system as set forth in claim 30, wherein the mobile terminal stores game status information not including the transferred resultant game score upon receipt of the message indicating the record success, and stores game status information including the transferred resultant game score upon receipt of the message indicating the record failure.

32. The system as set forth in claim 30, wherein the mobile terminal displays the message indicating the record failure on a display of the mobile terminal, upon receipt of the message indicating the record failure.

33. The system as set forth in claim 32, wherein the resultant game score includes at least one of a name of the character, a retention item and a usage item of the character, level information indicating at least one ability of the character, and position information of the character.

34. An interactive game method utilizing a mobile terminal, an online game server, and a mobile game server, said mobile terminal for downloading a game that is executable in an offline mode, playing the downloaded game, said online game server for providing a user with a communication service needed to execute the game in an online mode, and said mobile game server for connecting the mobile terminal with the online game server, said method comprising the steps of:
a) transmitting update information including number information of the mobile terminal and a resultant game score over a wireless channel;
b) upon receiving the number information included in the update information, updating the resultant game score in a memory, which stores the number information of the mobile terminal and the resultant game score corresponding to the number information, and transmitting the update information to the online game server;
c) detecting the resultant game score from the update information;
d) upon receipt of the detected resultant game score, determining whether a registration character associated with the resultant game score is found;
e) if it is determined that the character has been found, recording the resultant game score in the character.

35. The method as set forth in claim 34, further comprising the steps of:
f) determining a presence of the character corresponding to the resultant game score, and transmitting update result information indicating a success of recording the resultant game score in the character to the mobile game server according to the determination result;
g) analyzing the update result information; and
h) if it is determined that the resultant game score has been successfully recorded in the character, transmitting a message indicating record success of the resultant game score to the mobile terminal.

36. The method as set forth in claim 35, further comprising the step of:
i) transmitting a message indicating record failure of the resultant game score to the mobile terminal, if it is determined that the resultant game score has not been successfully recorded in the character at step (g).

37. The method as set forth in claim 36, further comprising the steps of:
j) upon receipt of the message indicating the record success, storing game status information not including the transferred resultant game score; and
k) upon receipt of the message indicating the record failure, storing game status information including the transferred resultant game score.

38. The method as set forth in claim 37, further comprising the step of:
l) upon receipt of the message indicating the record failure, displaying the message indicating the record failure on a display of the mobile terminal.

39. The method as set forth in claim 38, wherein the resultant game score includes at least one of a name of the character, a retention item and a usage item of the character, level information indicating at least one ability of the character, and position information of the character.
